(19) United States
(12) Patent Application Publication
(10) Pub. No.: US 2014/0042324 A1
(43) Pub. Date: Feb. 13, 2014

(54) DETECTOR AND METHOD OF CONTROLLING THE SAME

(71) Applicant: Agency for Science, Technology and Research, Singapore (SG)

(72) Inventors: Piotr Kropelnicki, Singapore (SG); Ming Lin Julius Tsai, Singapore (SG); Ilker Ender Ocak, Singapore (SG); Andrew Randles, Singapore (SG)

(73) Assignee: Agency for Science, Technology and Research, Singapore (SG)

(21) Appl. No.: 13/961,347

(22) Filed: Aug. 7, 2013

(30) Foreign Application Priority Data
Aug. 8, 2012 (SG) 201205907-7

(51) Int. Cl. G01J 5/02

(52) U.S. Cl. CPC G01J 5/02
USPC 250/340; 250/338.1

(57) ABSTRACT

According to embodiments of the present invention, a detector is provided. The detector includes an electromagnetic absorber, an electromagnetic reflector arranged spaced apart from the electromagnetic absorber, wherein the electromagnetic absorber is configured to absorb an electromagnetic radiation, the electromagnetic radiation having a wavelength defined based on a distance between the electromagnetic absorber and the electromagnetic reflector, and an actuating element configured to move the electromagnetic absorber from an equilibrium position bi-directionally relative to the electromagnetic reflector to change the distance, and wherein the detector is configured to determine a change in a property associated with the electromagnetic absorber in response to the electromagnetic radiation. According to further embodiments of the present invention, a method of controlling the detector is also provided.

### CROSS-REFERENCE TO RELATED APPLICATION

This application claims the benefit of priority of Singapore patent application No. 201205907-7, filed 8 Aug. 2012, the content of it being hereby incorporated by reference in its entirety for all purposes.

### TECHNICAL FIELD

Various embodiments relate to a detector and a method of controlling the detector.

### BACKGROUND

Microelectromechanical systems (MEMS) based uncooled far infrared (FIR) sensors (microbolometers) are currently gaining more attention due to their wide application areas, e.g. traffic safety, fire fighting or heat leakage detection in buildings. Nevertheless, this kind of sensor absorbs the spectrum of infrared (IR) light within a limited bandwidth without giving any quantitative information about the amount of absorbed infrared light for a specific wavelength. However, knowing the quantitative amount of absorbed infrared light for a specific wavelength and scanning through several wavelengths may be useful as this makes it possible to reconstruct the spectrum, which is emitted by the observed object, quantitatively.

Nowadays, so called Hyperspectral Imaging (HSI) and Multispectral Imaging (MSI) systems are quite promising for imaging applications, using mercury cadmium telluride (HgCdTe) or quantum dots (QDs) as sensors. However, these sensor solutions are not complementary metal-oxide-semiconductor (CMOS) compatible and need to be actively cooled down to 77K in order to maintain sensor sensitivity. High power demands and high fabrication costs also prevent the breakthrough for these kinds of sensors within the low cost consumer market.

An approach using uncooled vanadium oxide (VOx) based microbolometer with an extensive optical system to form a Sagnac interferometer for wavelength selection has been employed. However, due to the stiffness of the vanadium oxide (VOx) microbolometer, only wavelengths within the far infrared range can be detected, with a moderate sensor resolution especially at the edge of the spectrum. Additionally, the operating temperature is limited to temperatures of 85° C., which limits high temperature applications, e.g. remote sensing in space or gas detection in ruggedized environment.

Therefore there is a need for a low cost solution with miniaturized dimensions, which may also be capable of operating at high temperatures. In addition, a detection method, including for both MIR and FIR spectra, may enable a way to analyze our surroundings, by acquiring more information and correlate them to one image.

### SUMMARY

According to an embodiment, a detector is provided. The detector may include an electromagnetic absorber, an electromagnetic reflector arranged spaced apart from the electromagnetic absorber, wherein the electromagnetic absorber is configured to absorb an electromagnetic radiation, the electromagnetic radiation having a wavelength defined based on a distance between the electromagnetic absorber and the electromagnetic reflector, and an actuating element configured to move the electromagnetic absorber from an equilibrium position bi-directionally relative to the electromagnetic reflector to change the distance, and wherein the detector is configured to determine a change in a property associated with the electromagnetic absorber in response to the electromagnetic radiation.

According to an embodiment, a method of controlling a detector is provided. The method may include operating an actuating element of the detector to move an electromagnetic absorber of the detector from an equilibrium position in a direction selected from two opposite directions the electromagnetic absorber is movable, relative to an electromagnetic reflector of the detector arranged spaced apart from the electromagnetic absorber to change a distance between the electromagnetic absorber and the electromagnetic reflector, wherein the electromagnetic absorber is configured to absorb an electromagnetic radiation, the electromagnetic radiation having a wavelength defined based on the distance, and determining a change in a property associated with the electromagnetic absorber in response to the electromagnetic radiation.

### BRIEF DESCRIPTION OF THE DRAWINGS

In the drawings, like reference characters generally refer to like parts throughout the different views. The drawings are not necessarily to scale, emphasis instead generally being placed upon illustrating the principles of the invention. In the following description, various embodiments of the invention are described with reference to the following drawings, in which:

FIG. 1A shows a schematic block diagram of a detector, according to various embodiments.

FIG. 1B shows a cross-sectional representation of the detector of the embodiment of FIG. 1A.

FIG. 1C shows a flow chart illustrating a method of controlling a detector, according to various embodiments.

FIG. 2A shows a schematic cross sectional view of a detector, according to various embodiments.

FIG. 2B shows a schematic top view of a microbolometer, according to various embodiments.

FIG. 2C shows a scanning electron microscope (SEM) image showing a top view of a microbolometer, according to various embodiments.

FIG. 3A shows a plot of simulation results for the bolometer temperature against the response time for a detector.

FIG. 3B shows a plot of temperature coefficient of frequency (TCF) against temperature.

FIG. 3C shows a simulated temperature distribution of a detector.

FIG. 3D shows a plot of resonance frequency shift for a detector for different temperatures.

FIGS. 4A and 4B show perspective views of a microbolometer having unimorph bolometer leg structures with an applied potential and at ground respectively.

FIG. 4C shows a simulated displacement of a microbolometer based on the embodiments of FIGS. 4A and 4B at an applied potential of about 20 V, according to various embodiments.

FIG. 4D shows a simulated displacement of a microbolometer based on the embodiments of FIGS. 4A and 4B due to thermal stress, according to various embodiments.

FIG. 4E shows a simulated displacement of a microbolometer based on the embodiments of FIGS. 4A and 4B due to thermal stress and with an applied potential of about 20 V, according to various embodiments.

FIGS. 5A and 5B show perspective views of a microbolometer having bimorph bolometer leg structures with an applied potential and at ground respectively.

FIG. 5C shows a simulated displacement of a microbolometer based on the embodiments of FIGS. 5A and 5B at an applied potential of about 20 V, according to various embodiments.

FIG. 5D shows a simulated displacement of a microbolometer based on the embodiments of FIGS. 5A and 5B due to thermal stress, according to various embodiments.

FIG. 5E shows a simulated displacement of a microbolometer based on the embodiments of FIGS. 5A and 5B due to thermal stress and with an applied potential of about 20 V, according to various embodiments.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Embodiments described in the context of one of the methods or devices are analogously valid for the other method or device. Similarly, embodiments described in the context of a method are analogously valid for a device, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element includes a reference to one or more of the features or elements.

In the context of various embodiments, the term “about” or “approximately” as applied to a numeric value encompasses the exact value and a reasonable variance.

As used herein, the term “and/or” includes any and all combinations of one or more of the associated listed items.

Various embodiments may relate to rugged electronic devices.

Various embodiments may provide a detector, such as an infrared (IR) sensor, employing a tunable microbolometer structure for multispectral imaging.

Various embodiments may provide a detector including a bolometer or a microbolometer. The microbolometer may include a microbolometer absorber, for example which may be positioned over a microbolometer membrane. The detector may include a tunable Fabry-Perot (FP) infrared (IR)-light absorption structure, for example including the microbolometer and a reflector, for wavelength selection. The distance between the microbolometer and the reflector of the FP-structure may define the desired wavelength. The microbolometer may include one or more microbolometer legs having a piezoelectric actuator. The microbolometer may include one or more piezoelectric cantilever actuators, for example formed by the microbolometer leg(s) with the piezoelectric actuator, employed to move the microbolometer in the +/−z-axis direction. The piezoelectric actuator may have a piezoelectric material or layer of any suitable material, including but not limited to aluminium nitride (AlN), lead zirconate titanate (PZT), zinc oxide (ZnO), or lithium niobate (LiNbO₃). The piezoelectric actuator may have a bimorph piezoelectric structure for movement enhancement, for example, for the absorber part of the detector. The detector may further include a tunable Fabry-Perot (FP)-filter on top of the microbolometer to increase the desired wavelength selectivity.

It should be appreciated that for the bolometer or microbolometer, different structures or configurations may be used, for example including but not limited to an acoustic wave based microbolometer (e.g. including a surface acoustic wave (SAW) microbolometer), metal based bolometer, resistive type of bolometer or any other kinds of bolometer. The microbolometer structure may include one or more bolometer legs and an electromagnetic (EM) (e.g. infrared (IR)) absorption area or region, e.g. an EM absorber.

In the context of various embodiments, the term “surface acoustic wave” may mean an acoustic wave traveling along the surface of a material exhibiting elasticity, for example a piezoelectric material, with an amplitude that typically decays exponentially with depth into the material. As the acoustic wave propagates through or on the surface of the material, any changes to the characteristics of the propagation path may affect the velocity and/or amplitude of the wave.

Various embodiments may provide a piezoelectric tunable microbolometer structure for spectral imaging, for example a piezoelectric actuated micromechanical structure for multispectral and hyperspectral mid and far infrared (IR) detection or imaging. In various embodiments, by using a piezoelectric actuator on the bolometer legs, it may be possible to move the absorber and the bolometer membrane in or along the z-axis, without having any constraints in the movement freedom. In various embodiments, the absorber and the bolometer membrane may be movable bidirectionally along the z-axis, i.e. ±z-direction. Further, in various embodiments, by using a double piezoelectric, bimorph cantilever and inserting a buffer material in between, it may be possible to achieve an ambient temperature independent piezoelectric driven movement behavior of the bolometer membrane.

The detector of various embodiments may provide an approach that addresses or overcomes the drawbacks of conventional devices, where (1) no moveable Fabry-Perot Perot (FP) filter IR absorption structure with high movement freedom is available, and/or (2) movement that is constrained to the negative z-axis (unidirectional) and with pull in effect, and/or (3) structures employing electrostatic force that are temperature unstable.

An object emitting IR-light possesses its own specific spectrum, which may be detected and displayed quantitatively by the detector or IR sensor of various embodiments for multi- and hyper-spectral imaging. By detecting the emitted spectrum of a material within the mid infrared (MIR) and far infrared (FIR) range (e.g. between about 2 μm and about 20 μm), it may be possible to obtain information about the physical structure, chemical composition and temperature of this material.

Various embodiments may include one or more of the following : (1) use of piezoelectric actuated cantilever for microbolometer movement; (2) use of bimorph or unimorph piezoelectric actuator to form a tunable Fabry-Perot (FP) infrared (IR)-absorption structure; (3) use of bimorph piezoelectric actuator to enhance z-axis absorber and microbolometer membrane movement; (4) use of bimorph piezoelectric actuator with temperature stress compensation to stabilize the microbolometer membrane movement over temperature; (5) active temperature regulation for unimorph cantilever structure; (6) minimal or no constrain in movement for microbolometer in or along the +/−z-axis (no pull in effect); (7) extreme temperature stable material (up to about 300° C.), thereby providing more reliable packaging; (8) ambient temperature (up to about 300° C.) independent FP IR bimorph cantilever absorption structure, even with IR sensor heat-up.

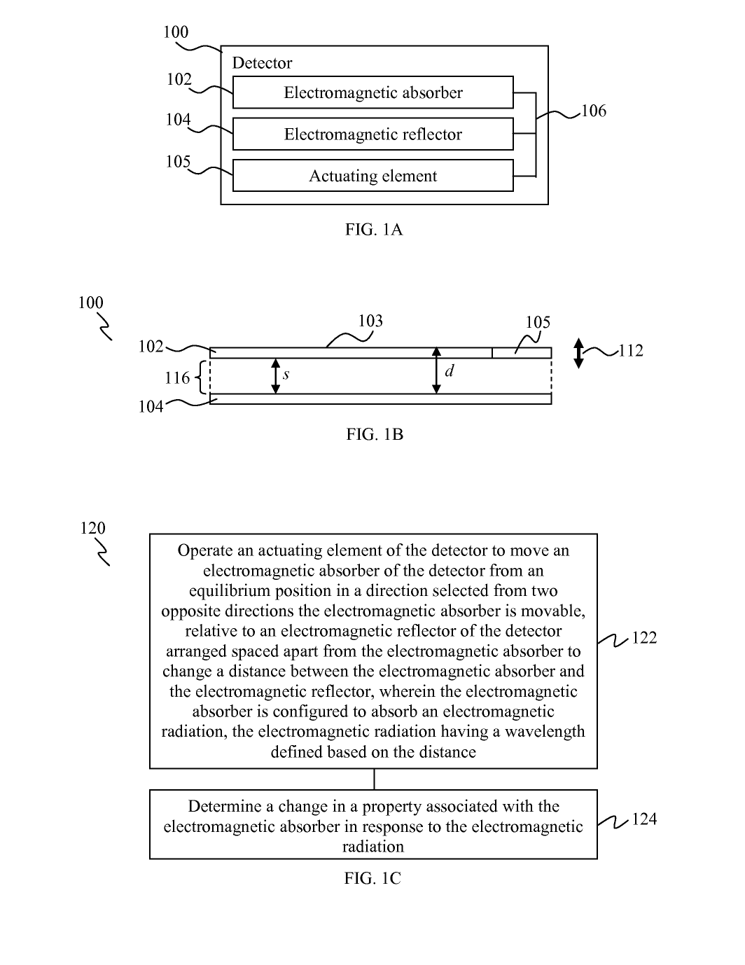

FIG. 1A shows a schematic block diagram of a detector 100 while FIG. 1B shows a cross-sectional representation of the detector 100, according to various embodiments. The detector 100 includes an electromagnetic (EM) absorber 102, an electromagnetic (EM) reflector 104 arranged spaced apart from the EM absorber 102, wherein the EM absorber 102 is configured to absorb an electromagnetic (EM) radiation, the EM radiation having a wavelength defined based on a distance, d, between the EM absorber 102 and the EM reflector 104, an actuating element 105 configured to move the EM absorber 102 from an equilibrium position bi-directionally relative to the EM reflector 104 to change the distance, d, and wherein the detector 100 is configured to determine a change in a property associated with the EM absorber 102 in response to the EM radiation. In FIG. 1A, the line represented as 106 is illustrated to show the relationship between the EM absorber 102, the EM reflector 104 and the actuating element 105, which may include optical coupling and/or electrical coupling and/or mechanical coupling.

In other words, the detector 100 may include an EM absorber (e.g. IR absorber) 102 and an EM reflector (e.g. IR reflector) 104 arranged spaced apart from each other, for example by a gap (e.g. an air gap) 116. The EM absorber 102 may be arranged over the EM reflector 104. In this way, the EM absorber 102 may levitate or be suspended over or above the EM reflector 104.

The EM absorber 102 may absorb an EM radiation (e.g. IR light or radiation), where the wavelength of the EM radiation may be related to the distance, d, between the EM absorber 102 and the EM reflector 104. The distance, d, may include a spacing, s, of the gap 116. This may mean that the EM radiation having a wavelength defined in relation to the distance, d, may be maximally or optimally absorbed by the EM absorber 102.

Absorption of the EM radiation by the EM absorber 102 may cause a temperature increase (heating) of the EM absorber 102, which consequently may result in a change in a property or parameter associated with the EM absorber 102 in response to the EM radiation absorbed. The detector 100 may then detect or determine this property change associated with the temperature change/increase which may correlate to the energy of the absorbed EM radiation. For example, a read-out of the property change may be performed. This change in the property may give an indication of the EM radiation absorbed and its associated amount or intensity. Further, the detector 100 may include an actuating element 105 adapted to move or deflect the EM absorber 102 from an equilibrium position bi-directionally (e.g. in two opposite directions), as represented by the double-headed arrow 112, relative to the EM reflector 104, to change the distance, d. This may mean that the EM absorber 102 may be movable bi-directionally in two opposite directions, for example in a “positive” direction from an origin corresponding to the equilibrium position, and a “negative” direction from the origin. As a non-limiting example, the EM absorber 102 may be moved or deflected in a direction normal or perpendicular to the top surface 103 of the EM absorber 102 in the equilibrium position. By changing the distance, d, an EM radiation of a wavelength associated with the changed distance may be absorbed by the EM absorber 102.

In various embodiments, the EM reflector 104 may be static, stationary or non-moveable. For example, the EM reflector 104 may be formed or arranged on a substrate.

In various embodiments, the EM reflector 104 may be configured to reflect at least part of an initial electromagnetic (EM) radiation incident on the detector 100 towards the EM absorber 102 for the electromagnetic (EM) radiation to be absorbed by the EM absorber 102. This may enhance absorption by the EM absorber 102.

In the context of various embodiments, the term “electromagnetic radiation” may include infrared (IR), for example including mid infrared (MIR) and/or far infrared (FIR).

In the context of various embodiments, the term “equilibrium position” may mean an initial position, a resting position, a non-actuated position, or the like. In various embodiments, the EM absorber 102 and the EM reflector 104 in their respective equilibrium positions may define an initial distance, d₀, between the EM absorber 102 and the EM reflector 104.

In the context of various embodiments, the property associated with the EM absorber 102 may include a property of the EM absorber 102, e.g. resistance of the EM absorber 102.

In the context of various embodiments, the property associated with the EM absorber 102 may include a temperature-dependent property, e.g. resistance and/or frequency, e.g. frequency of an acoustic wave generated by the EM absorber 102.

In the context of various embodiments, the EM absorber 102 and the EM reflector 104 may form a Fabry-Perot (FP) like structure or cavity.

In the context of various embodiments, the EM reflector 104 may include a mirror (e.g. IR mirror) or a reflecting surface.

In the context of various embodiments, the distance, d, may be in a range of between about 0.5 μm and about 5 μm, for example between about 0.5 μm and about 3 μm, between about 0.5 μm and about 1 μm, between about 2 μm and about 5 μm, or between about 2 μm and about 3 μm.

In various embodiments, the actuating element 105 may be coupled to the EM absorber 102, for actuating movement of the EM absorber 102 to change the distance, d. The actuating element 105 may be integrated with the detector 100 or the EM absorber 102, for example an on-chip actuating element 105.

In various embodiments, the actuating element 105 may be or may include a piezoelectric material, for actuating movement of the EM absorber 102 to change the distance, d. The piezoelectric material may be integrated with the detector 100 or the EM absorber 102, for example an on-chip piezoelectric material. Therefore, the EM absorber 102 may be piezoelectrically actuated to change the distance, d.

In the context of various embodiments, the term “piezoelectric material” may mean a material that may induce electrical charges in response to an applied force or stress or that an applied electric field may cause a change in the dimension of the material. The piezoelectric material may be in the shape of a square, a rectangle or a circle. However, it should be appreciated that the piezoelectric material may be in any shape or form.

In the context of various embodiments, the piezoelectric material may be selected from the group consisting of aluminum nitride (AlN), zinc oxide (ZnO), lead zirconate titanate (PZT), quartz (SiO₂), aluminum gallium arsenide (AlGaAs), gallium arsenide (GaAs), silicon carbide (SiC), langasite (LGS), gallium nitride (GaN), lithium tantalite (LiTaO₃), lithium niobate (LiNbO₃) and polyvinylidene fluoride (PVDF) or any other materials that exhibit piezoelectricity effect.

In various embodiments, the detector 100 may further include at least one support structure coupled to the EM absorber 102, the at least one support structure including the piezoelectric material. The at least one support structure may be a leg structure, e.g. an actuation leg or a bolometer leg. The at least one support structure may have a cantilever like structure. The at least one support structure coupled to the EM absorber 102 may be arranged to couple to a substrate such that the EM absorber 102 may be suspended over the substrate. By suspending the EM absorber 202 over the substrate, the EM absorber 102 may be thermally isolated from the substrate.

In various embodiments, the at least one support structure may include a first support structure coupled to a first side of the EM absorber 102, and a second support structure arranged coupled to a second side of the EM absorber 102 opposite to the first side. This may mean that a pair of support structures may be provided, e.g. two actuation legs or bolometer legs. Each of the first support structure and the second support structure may have a cantilever like structure.

In various embodiments, the first support structure may be arranged to couple to the EM absorber 102 at a first position on the first side of the EM absorber 102, while the second support structure may be arranged to couple to the EM absorber 102 at a second position on the second side of the EM absorber 102. The first position and the second position each may include an edge region or side region of the EM absorber 102.

In various embodiments, the at least one support structure may include a dielectric material (e.g. SiO₂), wherein the piezoelectric material and the dielectric material may be arranged one over the other. In this way, a unimorph structure or cantilever-like structure may be formed. In various embodiments, the piezoelectric material may be arranged on top of the dielectric material. The piezoelectric material may be sandwiched between a pair of electrodes (e.g. TiN electrodes).

In various embodiments, the at least one support structure may further include another piezoelectric material, wherein the piezoelectric material and the other piezoelectric material may be arranged one over the other. In this way, a bimorph structure or cantilever-like structure may be formed. In various embodiments, the at least one support structure may further include a buffer material (e.g. SiO₂) between the piezoelectric material and the other piezoelectric material, the buffer material configured to provide compensation against thermal stress.

In various embodiments, the piezoelectric material may be sandwiched between a first pair of electrodes (e.g. TiN electrodes), and the other piezoelectric material may be sandwiched between a second pair of electrodes (e.g. TiN electrodes). In various embodiments, respective first electrodes of the first pair of electrodes and the second pair of electrodes may be electrically coupled to each other, and respective second electrodes of the first pair of electrodes and the second pair of electrodes may be electrically coupled to each other. This may mean that the respective first electrodes may have the same first potential, while the respective second electrodes may have the same second potential when an electrical signal is applied between the first and second pairs of electrodes. The the respective first electrodes may be arranged facing each other.

In various embodiments, the at least one support structure may include two or more piezoelectric materials (e.g. two, three, four or any higher number of piezoelectric materials). Therefore, the at least one support structure may have a multiple layer design of multiple piezoelectric materials. A corresponding buffer material may be arranged in between adjacent piezoelectric materials.

In various embodiments, the detector 100 may further include a thermally insulating material between the actuating element 105 and the EM absorber 102 to provide thermal isolation between the actuating element 105 and the EM absorber 102. The thermally insulating material may be employed for adjusting or controlling a thermal time constant of the EM absorber 102 or the detector 100. In various embodiments, the thermally insulating material may include silicon oxide (SiO₂) or silicon nitride (SiN). In various embodiments, the detector 100 may further include a thermal isolation structure or leg including the thermally insulating material.

In various embodiments, the EM absorber 102 may include an acoustic wave resonator including a pair of electrodes (e.g. TiN electrodes), and a piezoelectric structure, wherein the piezoelectric structure may be electrically coupled to the pair of electrodes, wherein the acoustic wave resonator may be configured to generate an acoustic wave, and wherein the detector 100 may be configured to determine a change in a frequency (e.g. resonant frequency) of the acoustic wave in response to the EM radiation.

In various embodiments, the pair of electrodes may be provided on only one surface. This may generate a surface acoustic wave on only one surface.

In various embodiments, the pair of electrodes may be arranged in a first layer and the piezoelectric structure may be arranged in a second layer adjacent to the first layer. The second layer may be arranged proximate to the EM reflector 104, between the first layer and the EM reflector 104.

In the context of various embodiments, the term “piezoelectric structure” may share the same definition as defined for the term “piezoelectric material”. In various embodiments, the piezoelectric structure may function as an acoustic wave medium (e.g. a surface acoustic wave medium).

In the context of various embodiments, the term “resonator” may mean a device or a system that exhibits resonance, where the device may oscillate or resonate at relatively larger amplitudes at particular frequencies, known as its resonant frequencies, compared to the amplitudes of the oscillations at non-resonant frequencies. A resonator may be used to excite or generate waves such that an acoustic wave resonator may be used to generate acoustic waves in a medium. In various embodiments, the pair of electrodes and the piezoelectric structure may form a resonating microstructure where the piezoelectric structure may be electrically coupled to the pair of electrodes such that the pair of electrodes may excite an acoustic wave to propagate within or on the piezoelectric structure.

In the context of various embodiments, the term “acoustic wave resonator” may include for example LFE-FBAR (Lateral Field Excited Film Bulk Acoustic-Wave Resonator). In various embodiments, the acoustic wave resonator may excite an acoustic wave, which includes but is not limited to the following waves, for example, surface acoustic wave (SAW), LFE-FBAR mode, Checker-Mode, or any wave that may be excited.

In the context of various embodiments, the piezoelectric structure may be electrically coupled to the pair of electrodes such that the pair of electrodes may excite or generate an acoustic wave. In this context, the term “electrically coupled” may mean that the piezoelectric structure is in electrical communication with the pair of electrodes such that an electrical current flowing through the pair of electrodes (or an electrical voltage applied to the pair of electrodes) may cause an effect (e.g. deformation) on the piezoelectric structure, for example generating an acoustic wave to propagate on or within the piezoelectric structure. In various embodiments, the resonant frequency of the acoustic wave resonator, and that of the acoustic wave generated, may be determined based on the geometrical arrangement of the pair of electrodes.

In various embodiments, each of the pair of electrodes may include a plurality of teeth. This may mean that each electrode of the pair of electrodes may have a comb-shaped like arrangement.

In various embodiments, the pair of electrodes may be arranged in an interdigitated (IDT) pattern. This may mean that the pair of electrodes may be arranged such that each tooth of the plurality of teeth of one electrode is alternately arranged with each tooth of the plurality of teeth of the other electrode.

In various embodiments, the detector 100 may further include a filter for filtering an initial electromagnetic (EM) radiation incident on the detector 100 prior to reaching the EM absorber 102. The filter may be arranged over or above the EM absorber 102. The filter may be a Fabry-Perot (FP) filter.

In various embodiments, the filter may selectively pass through a filtered EM radiation of the desired wavelength or wavelength range to be absorbed by the EM absorber 102, and therefore which may be detected by the detector 100.

In various embodiments, the filter may be tunable for filtering different wavelengths of the initial EM radiation. For example, the filter may be a tunable FP filter.

In various embodiments, the filter may be an infrared (IR) filter, e.g. a tunable IR filter or a tunable Fabry Perot IR filter.

In the context of various embodiments, the detector 100 may include or may be an infrared (IR) detector. The IR detector may be configured to detect infrared (IR) radiation of a wavelength up to about 20 μm, for example between about 2 μm and 20 μm, between about 2 μm and 10 μm, between about 2 μm and 5 μm, between about 5 μm and 20 μm, between about 10 μm and 20 μm, or between about 5 μm and 15 μm.

In the context of various embodiments, the EM absorber 102 may include or may be a bolometer or a microbolometer. The microbolometer may be a CMOS compatible microbolometer. The microbolometer may include an acoustic wave based microbolometer, a metal based microbolometer, a resistive type microbolometer or any other kinds of microbolometer.

In the context of various embodiments, the detector 100 may be operable at a temperature of up to about 300° C., for example between room temperature (e.g. about 25° C.) and about 300° C., between about 25° C. and about 200° C., between about 25° C. and about 100° C., between about 100° C. and about 300° C., or between about 50° C. and about 200° C.

In the context of various embodiments, the detector 100 may be an uncooled detector. This may mean that the detector 100 may not require active cooling for operation.

In the context of various embodiments, the detector 100 may include or may be provided on a substrate (e.g. silicon (Si) substrate). The EM reflector 104 may be arranged on the substrate. In various embodiments, the substrate may include one or more CMOS circuits.

In the context of various embodiments, the terms “couple” and “coupled” may include electrical coupling and/or mechanical coupling.

In the context of various embodiments, the terms “couple” and “coupled” with regard to two or more components may include direct coupling and/or indirect coupling. For example, two components being coupled to each other may mean that there is a direct coupling path between the two components and/or there is an indirect coupling path between the two components, e.g. via one or more intervening components connected therebetween.

FIG. 1C shows a flow chart 120 illustrating a method of controlling a detector, according to various embodiments.

At 122, an actuating element of the detector is operated to move an electromagnetic (EM) absorber of the detector from an equilibrium position in a direction selected from two opposite directions the electromagnetic absorber is movable, relative to an electromagnetic (EM) reflector of the detector arranged spaced apart from the electromagnetic absorber to change a distance, d, between the electromagnetic absorber and the electromagnetic reflector, wherein the electromagnetic absorber is configured to absorb an electromagnetic radiation, the electromagnetic radiation having a wavelength defined based on the distance. This may mean that the EM absorber may be movable in two opposite directions, where the EM absorber may be moved, relative to the EM reflector, in one direction of the two opposite directions such that the distance, d, may be changed by means of operation of the actuating element.

At 124, a change in a property associated with the electromagnetic absorber in response to the electromagnetic radiation is determined.

In various embodiments, the EM absorber may be movable from the equilibrium position bi-directionally in the two opposite (or opposing) directions relative to the EM reflector, and the actuating element may be operated to move the EM absorber from the equilibrium position in one direction (e.g. a “positive” direction) out of the two possible opposite directions or in the opposite direction (e.g. a “negative” direction).

In various embodiments, at 122, the actuating element may be operated to move the EM absorber of the detector from the equilibrium position bi-directionally in the two opposite directions relative to the EM reflector. This may mean that the EM absorber may be moved in one direction and then in the opposite direction.

In various embodiments, the actuating element may be coupled to the EM absorber.

In various embodiments, the actuating element may include or may be a piezoelectric material. This may mean that EM absorber may be piezoelectrically actuated, by means of the piezoelectric material, to change the distance, d.

The detector of various embodiments will now be described by way of the following non-limiting examples, based on an acoustic wave microbolometer.

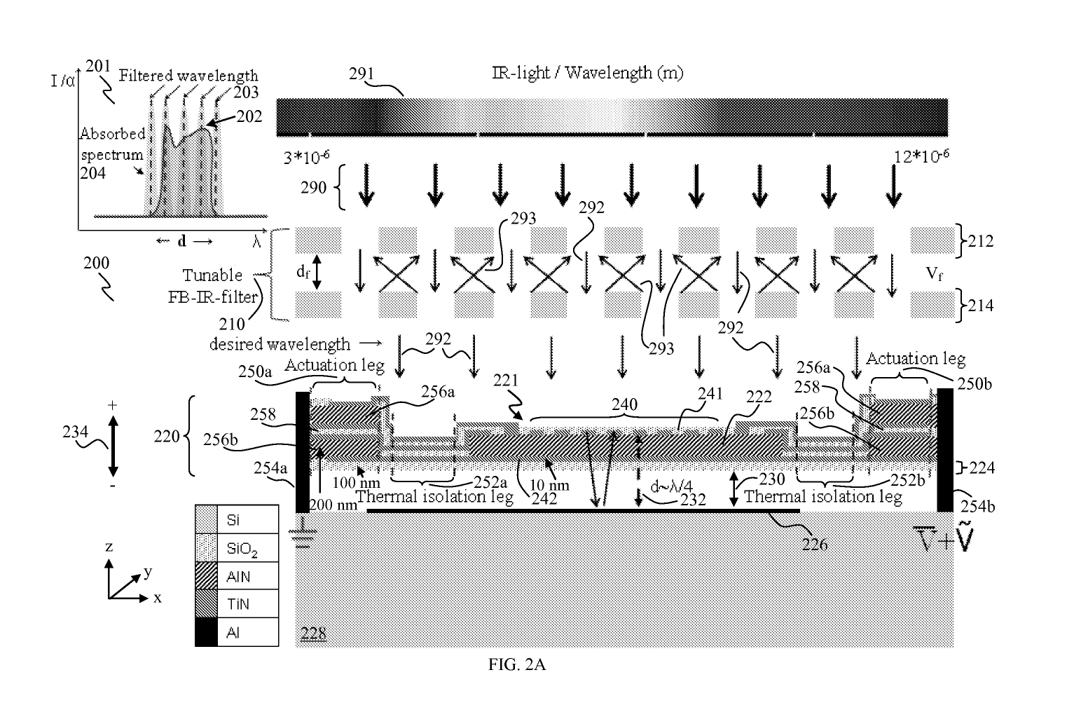

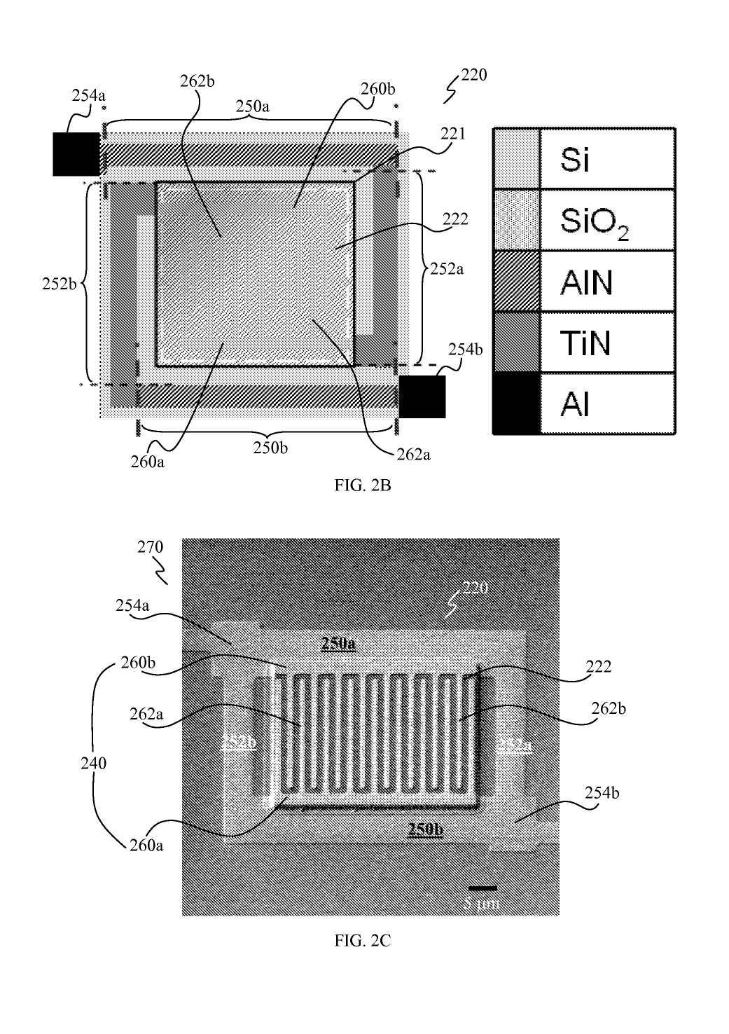

FIG. 2A shows a schematic cross sectional view of a detector 200, according to various embodiments. As a non-limiting example, the detector 200 will be described based on an acoustic wave based microbolometer (e.g. a surface acoustic wave (SAW) microbolometer) for infrared (IR) applications. FIG. 2A illustrates a structure suitable for multi- and hyperspectral imaging including a tunable IR-light filter and an IR-light detector.

The detector 200 may include a tunable Fabry Perot (FP) infrared (IR) filter 210 for wavelength filtering and a movable microbolometer structure 220 for IR absorption. The tunable IR filter 210 may be provided prior to the microbolometer 220, for example over or above the microbolometer 220, where the filter 210 may be employed for filtering out the desired wavelength, for example from the emitted spectrum of a material. This may mean that the filter 210 may receive light (e.g. IR light), as represented by the arrows 290, having a spectrum as represented by 291, across a range of wavelengths (e.g. between about 3×10⁻⁶ m and about 12×10⁻⁶ m; 3 μm-12 μm), and selectively pass light, as represented by the arrows 292, of a desired wavelength or a desired wavelength range to the microbolometer 220 for absorption by the microbolometer 220 for detection, while blocking light, as represented by the arrows 293, of undesired wavelengths which may not be of interest for detection by the detector 200. In this way, the filter 210 may receive light across a broad band of wavelengths and may selectively pass light of a wavelength or light across a narrow band of wavelengths as the filtered light.

In various embodiments, the filter 210 may include a pair of reflectors (e.g. mirrors, reflecting surfaces); a first reflector 212 and a second reflector 214 arranged spaced apart from each other by a gap, defining a cavity therebetween, where the distance, d_{f}, of the gap may determine the filter wavelength(s) such that light of a wavelength or wavelength range corresponding to the filter wavelength(s) may be passed through by the filter 210. A voltage, V_{f}, may be applied between the first reflector 212 and the second reflector 214 to change the distance, d_{f}, so as to change the filter wavelength(s), thus making the filter 210 tunable.

The detector 200 has a microbolometer structure 220 in a Fabry-Perot (FP) like structure having an IR absorber 221 positioned on a suspended microbolometer membrane 224 and an underlying IR reflector or mirror 226. The IR reflector 226 may be made of aluminium (Al) or may have a surface coated with aluminium. The IR reflector 226 may be formed or arranged on a substrate (e.g. silicon (Si) substrate) 228. The microbolometer membrane 224 may be a layer of silicon oxide (SiO₂), for example of a thickness of about 100 nm.

The IR absorber 221 may include a piezoelectric structure 222, for example of a material such as aluminium nitride (AlN). The piezoelectric structure 222 may have a rectangular shape. The IR absorber 221 may further include a pair of electrodes (e.g. titanium nitride (TiN) electrodes) formed or arranged in an interdigitated (IDT) structure or pattern, as represented by 240 (please refer to FIG. 2B for a top view of the pair of electrodes), over a top surface of the piezoelectric structure 222. The pair of electrodes 240 and the piezoelectric structure 222 may form an acoustic wave resonator, e.g. a surface acoutic wave resonator. The pair of electrodes 240 may be electrically coupled to the piezoelectric structure 222, where the acoustic wave resonator may generate an acoustic wave (e.g. a surface acoustic wave). For example, an acoustic wave may be generated by applying an electric field on the pair of electrodes 240. Further, the pair of electrodes 240 may act as an infrared (IR)-absorption layer as well as a contact layer. This may mean that the pair of electrodes 240 may act as an absorber, in addition to acting as an electrical contact. An electrode (e.g. TiN electrode) 242, for example of a thickness of about 10 nm, may be provided beneath the piezoelectric structure 222, and which may be electrically coupled to the piezoelectric structure 222. A passivation layer (e.g. SiO₂ layer) 241 may be provided over the pair of electrodes 240.

The IR absorber 221 may be spaced apart from the IR reflector 226 by a gap (e.g. an air gap), as represented by the double-headed arrow 230. Therefore, the IR absorber 221 may be suspended or levitate over or above the IR reflector 226. During fabrication, a sacrificial layer (e.g. amorphous silicon) may be formed over the substrate 228, for example between the substrate 228 and the membrane 224, where the sacrificial layer may then be subsequently etched away to define the gap 230.

The IR absorber 221 may receive the light 292 and absorb a portion of the light 291 of a wavelength that may be defined based on the distance between the IR absorber 221 and the IR reflector 226. As a non-limiting example, the distance, d, between the IR absorber 221 and the IR reflector 226 may be defined as the distance between the top surface of the IR absorber 221 and the top surface of the IR reflector 226, as represented by the double-headed arrow 232. However, it should be appreciated that the distance between the IR absorber 221 and the IR reflector 226 may also be defined in other ways, for example as the distance of the gap 230 or the distance between the bottom surface of the IR absorber 221 and the top surface of the IR reflector 226. The distance, d, between the IR absorber 221 and the IR reflector 226 may define the absorption maximum of the desired wavelength, λ, based on the relationship, d=λ/4. The IR reflector 226 may reflect at least a portion of the light 292 towards the IR absorber 221 to enhance absorption.

The light absorbed by the IR absorber 221 may cause heating of the IR absorber 221. As a result of the heating, a property associated with the IR absorber 221 may be changed, for example a change in the frequency (e.g. resonant frequency) of the acoustic wave generated. The property change may be determined by the detector 200, which may provide an indication of the light and the associated intensity absorbed by the IR absorber 221.

By suspending the IR absorber 221 at a distance from the IR reflector 226, the IR absorber 221 may also be arranged to levitate, float or be suspended at a distance from the substrate 228 with the gap 230 in between. This may minimise energy (e.g. thermal energy or heat) loss through the substrate 228, thereby providing a thermal isolation effect between the IR absorber 221 (and consequently the bolometer 220) and the substrate 228.

The microbolometer structure 220 may further include two support structures, in the form of bolometer legs which may act as actuation legs, e.g. a first bolometer or actuation leg 250a and a second bolometer or actuation leg 210b arranged on opposite sides of the IR absorber 221. The first actuation leg 250a and the second bolometer may be coupled to respective opposite edge regions of the IR absorber 221, via respective thermal isolation legs. The first actuation leg 250a may be coupled to the IR absorber 221 via a first thermal isolation leg 252a, while the second actuation leg 250b may be coupled to the IR absorber 221 via a second thermal isolation leg 252b. The first thermal isolation leg 252a and the second thermal isolation leg 252b may be provided for the thermal time constant adjustment of the bolometer 220.

The first actuation leg 250a may be coupled to a first anchor structure 254a for coupling to the substrate 228, while the second actuation leg 250b may be coupled to a second anchor structure 254b for coupling to the substrate 228. Each of the first anchor structure 254a and the second anchor structure 254b may be conductive, for example including a metallic material (e.g. Al). The first anchor structure 254a and the second anchor structure 254b may be coupled to one or more complementary metal-oxide-semiconductor readout integrated circuits (CMOS ROIL), for example which may be provided or integrated with the substrate 228. The CMOS circuit(s), for example, may be employed for determining a change in a property associated with the IR absorber 221 in response to the absorbed light.

Each of the first thermal isolation leg 252a and the second thermal isolation leg 252b may include a thermally insulating material (e.g. SiO₂) to provide thermal isolation between the IR absorber 221 and the respective first actuation leg 250a and the second actuation leg 250b. It should be appreciated that other materials having a thermal conductivity lower than respective thermal conductivities of the substrate 228, the first actuation leg 250a and the second actuation leg 250b may be employed as the thermally insulating material.

Each of the first actuation leg 250a and the second actuation leg 250b may have a unimorph structure having a layer of piezoelectric material, or a bimorph structure having two layers of piezoelectric materials arranged one over the other. This may enable piezoelectric actuation of the microbolometer membrane 224 as well as the IR absorber 221. Each of the first actuation leg 250a and the second actuation leg 250b may be SiO₂ based, having a piezeoelectric material deposited thereon to form a unimorph cantilever, or two piezeoelectric materials deposited thereon to form a bimorph cantilever.

As a non-limiting example, each of the first actuation leg 250a and the second actuation leg 250b are shown in FIG. 2A as having a bimorph structure. Each of the first actuation leg 250a and the second actuation leg 250b may have a first piezoelectric material 256a arranged over a second piezoelectric material 256b, with a buffer material (e.g. SiO₂) 258 sandwiched in between. The buffer material 258 may provide compensation against thermal stress that may be induced, for example during operation of the detector 200 where thermal stress may be generated in the first actuation leg 250a and the second actuation leg 250b. Each of the first piezoelectric material 256a and the second piezoelectric material 256b may include aluminium nitride (AlN). However, it should be appreciated that other material, including but not limited to lead zirconate titanate (PZT), zinc oxide (ZnO) and lithium niobate (LiNbO₃) may also be used. Any one of or each of the first piezoelectric material 256a and the second piezoelectric material 256b may have a thickness of about 200 nm. Electrodes (e.g. TiN electrodes) may be provided coupled to the first piezoelectric material 256a and the second piezoelectric material 256b, as shown in FIG. 2A and as will be described later with reference to FIG. 7.

As the distance, d, between the IR absorber 221 and the IR reflector 226 may determine the absorption wavelength, λ, the absorption wavelength may be changed by changing the distance, d. Piezoelectric actuation of the IR absorber 221, for example via the first actuation leg 250a and/or the second actuation leg 250b, may be carried out to move or deflect the IR absorber 221, from its equilibrium or non-actuated position, bi-directionally as represented by the double-headed arrow 234 (e.g. along the z-axis), relative to the IR reflector 226 to change the distance, d.

For example, by applying an electrical potential on the electrodes of the cantilever structure of the first actuation leg 250a and/or the second actuation leg 250b, the first piezoelectric material 256a and/or the second piezoelectric material 256b may be squeezed or expanded, depending on the polarity of the potential, in the lateral direction (e.g. along the x-axis), which therefore may cause bending of the whole cantilever structure, as well as the SiO₂ layer of the membrane 224, in the z-direction. In this way, depending on the polarity of the potential applied, the IR absorber 221 may be moved in an upward direction in the “+z”-direction or in a downward direction in the “−z”-direction.

It should be appreciated that the electrodes associated with the first actuation leg 250a and the second actuation leg 250b, as well as the absorber material of the pair of electrodes 240 may be non reflective towards the infrared light 292. A thin TiN layer may be employed to fulfill this requirement.

FIG. 2A further shows a plot 201 illustrating the emitted 202, filtered 203 and absorbed IR-light spectrum 204. Therefore, by moving the membrane 224 and the IR absorber 221 along the z-direction within the +/−z-axis, the distance, d, between the IR absorber 221 and the IR reflector 226 may change, causing a shift of the IR-light absorption maximum, as represented by 204. Accordingly, with this method, it may be possible to scan through the whole IR spectrum from about 2 μm to about 20 μm, which combined with the tunable FP filter 210 may form a detector or a system, for example, for quantitative spectrum detection.

FIG. 2B shows a schematic top view of a microbolometer 220 while FIG. 2C shows a scanning electron microscope (SEM) image 270 showing a top view of a microbolometer 220, according to various embodiments, illustrating the geometrical layout of the microbolometer 220. The microbolometer 220 may include the IR absorber 221 defining an absorption area. The IR absorber 221 may include a pair of electrodes, e.g. a first electrode 260a and a second electrode 260b, arranged on the piezoelectric structure 222. The first electrode 260a may include a plurality of teeth or fingers, as represented by 262a for one tooth. The second electrode 260b may include a plurality of teeth or fingers, as represented by 262b for one tooth. This may mean that each of the first electrode 260a and the second electrode 260b may have a comb-shaped like arrangement. The first electrode 260a and the second electrode 260b may form an interdigitated (IDT) pattern or configuration, such that a tooth 262a of the first electrode 260a may be arranged alternately with a tooth 262b of the second electrode 260b.

As shown in FIGS. 2B and 2C, a double corner leg structure or assembly may be provided coupled to the absorber 221. The double corner leg structure may include an actuation leg 250a or 250b for z-axis movement and a corresponding thermal isolation leg 252a or 252b for the thermal time constant adjustment of the bolometer 220. For example, the first actuation leg 250a and the first thermal isolation leg 252a may be coupled to each other and form a corner at the coupling point, while the first actuation leg 250a may form another corner at or near the coupling point with the absorber 221.

It should be appreciated that other arrangements or configurations of a microbolometer design including one or more cantilevers may be employed. As a non-limiting example, a linear leg assembly may be employed, where an actuation leg coupled to a thermal isolation leg, which in turn is coupled to an absorber may be aligned in a straight line.

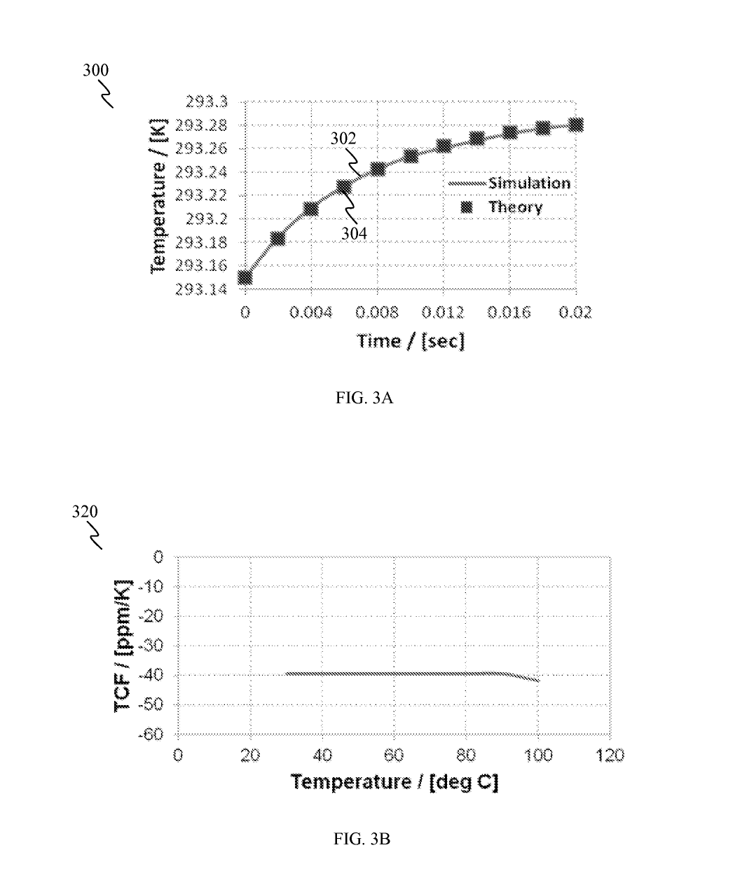

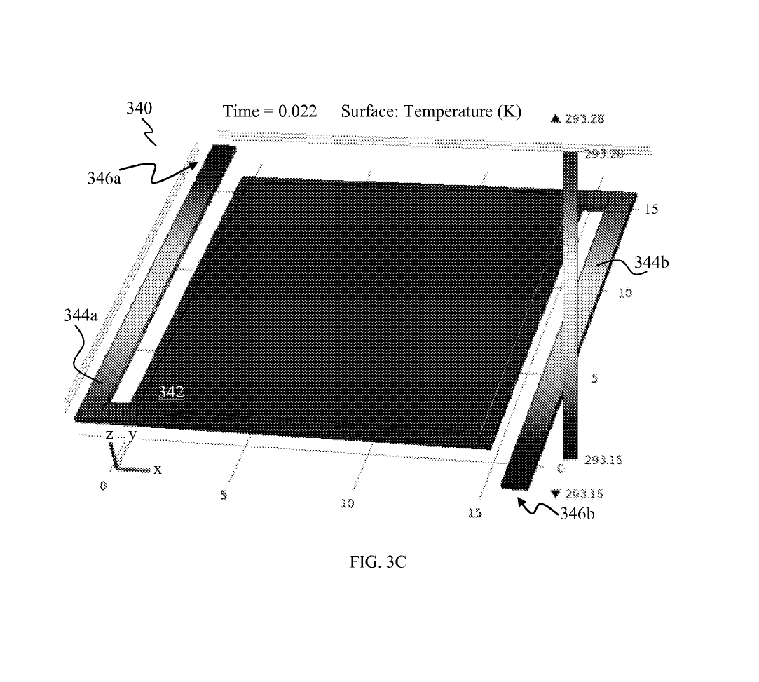

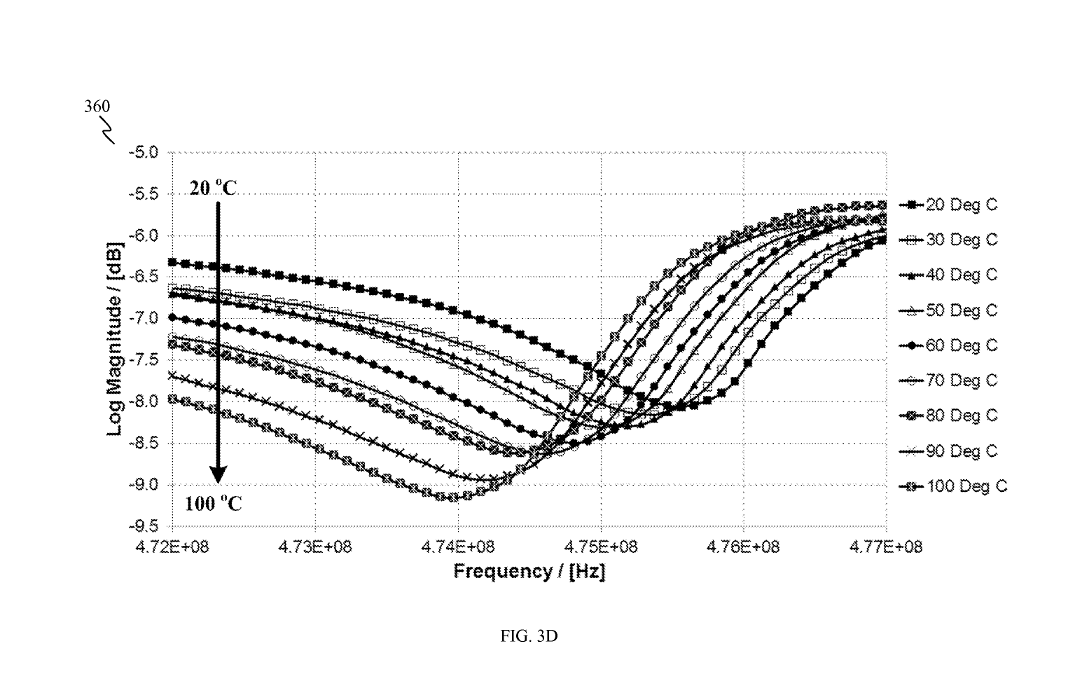

In order to facilitate understanding of the detector of various embodiments having a tunable microbolometer, results for a detector including a non-tunable acoustic wave microbolometer, where a piezoelectric material is absent from the bolometer legs, will now be described with reference to FIGS. 3A to 3D.

The response time of a microbolometer will now be described. The response time may refer to the minimum time to be waited for, after an object temperature is changed. By definition, the response time may be reached after more than 3 times of the thermal time constant, τₜₕ, (e.g. >3τₜₕ) and the signal output becomes 95% of its final value. Furthermore, the thermal time constant τₜₕ may be described by the microbolometer thermal capacity, c_{bolo}, divided by its thermal conductance, λ_{bolo}, as provided by equation 1 below.

$${τ}_{th} = ( \frac{{c}_{bolo}}{{λ}_{bolo}} ) . \qquad ( Equation 1 )$$

A non-limiting way for estimating the microbolometer thermal time constant, τₜₕ, may be given by

$$T ( t ) = {T}_{Sub} + Δ T ( 1 - {e}^{\frac{- t}{{τ}_{th}}} ) , \qquad ( Equation 2 )$$

where T(t) refers to the time dependent bolometer temperature, T_{Sub} refers to the substrate temperature, and ΔT refers to the temperature rise after exposing the sensor to a heat source.

The time dependent temperature behavior of the bolometer structure of various embodiments may be simulated using a finite element analysis software, to determine the thermal time constant, τₜₕ, and the thermal response time. FIG. 3A shows a plot 300 of simulation results 302 for the bolometer temperature against the response time. The results 302 show the simulated time dependent temperature, T(t), against time. For comparison purposes, the theoretical values, represented by the square data points (as indicated by 304 for one data point), are included in the plot 300. By using equation 2, the temperature behaviour may be modelled and the thermal time constant, τₜₕ, may be estimated to be about 7.4 ms, with the thermal response time approximately 22.2 ms.

FIG. 3B shows a plot 320 of temperature coefficient of frequency (TCF) against temperature, illustrating a TCF of approximately −40 ppm/K for temperatures up to about 90° C., and which then increase, in terms of magnitude, for temperatures above 100° C.

FIG. 3C shows a simulated temperature distribution of a detector 340. The detector 340 includes an absorber 342 coupled to a first bolometer leg 344a and a second bolometer leg 344b. The result shows that the temperature at the absorber 342 may be highest, where the temperature may decrease moving in a direction from the respective portions of the first bolometer leg 344a and a second bolometer leg 344b coupled to the absorber 342 towards the respective end portions 346a, 346b of the first bolometer leg 344a and the second bolometer leg 344b.

FIG. 3D shows a plot 360 of resonance frequency shift for a detector for different temperatures, illustrating measurement on the temperature behavior of the microbolometer. The plot 360 shows the results for temperatures of about 20° C., about 30° C., about 40° C., about 50° C., about 60° C., about 70° C., about 80° C., about 90° C., and about 100° C.

The principles of the piezoelectric tunable acoustic wave (AW) microbolometer of various embodiments will now be described by way of the following non-limiting examples. Simulation using a finite element analysis software may be performed based on a microbolometer structure having a double corner leg structure defined by an actuation leg for z-axis movement and a thermal isolation leg for thermal time constant adjustment of the microbolometer, similar to that of the embodiments of FIGS. 2B and 2C.

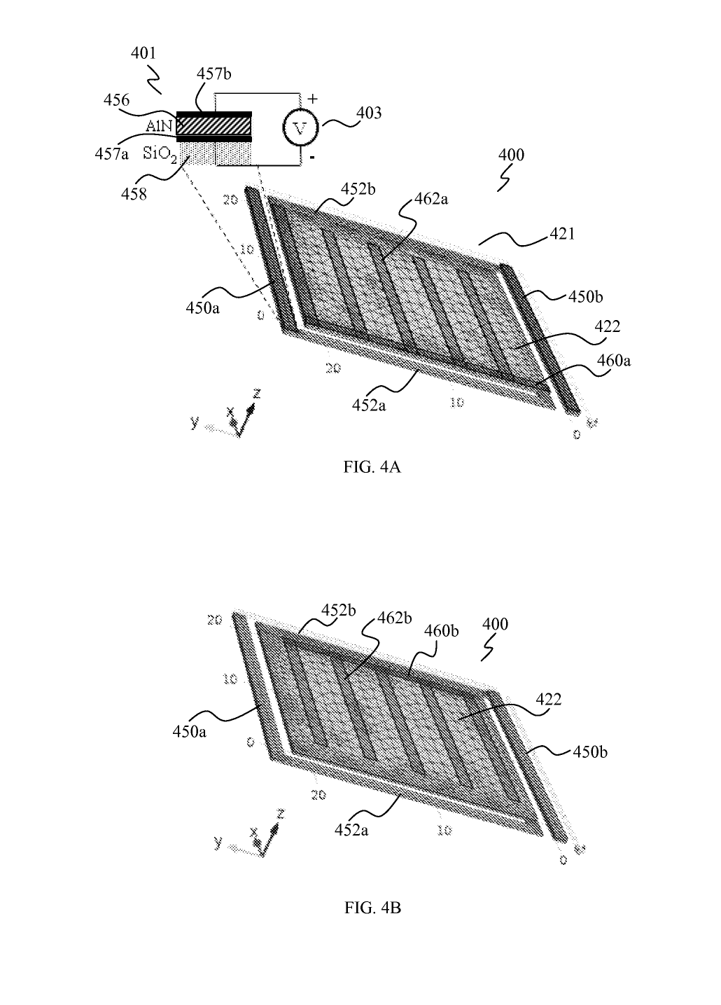

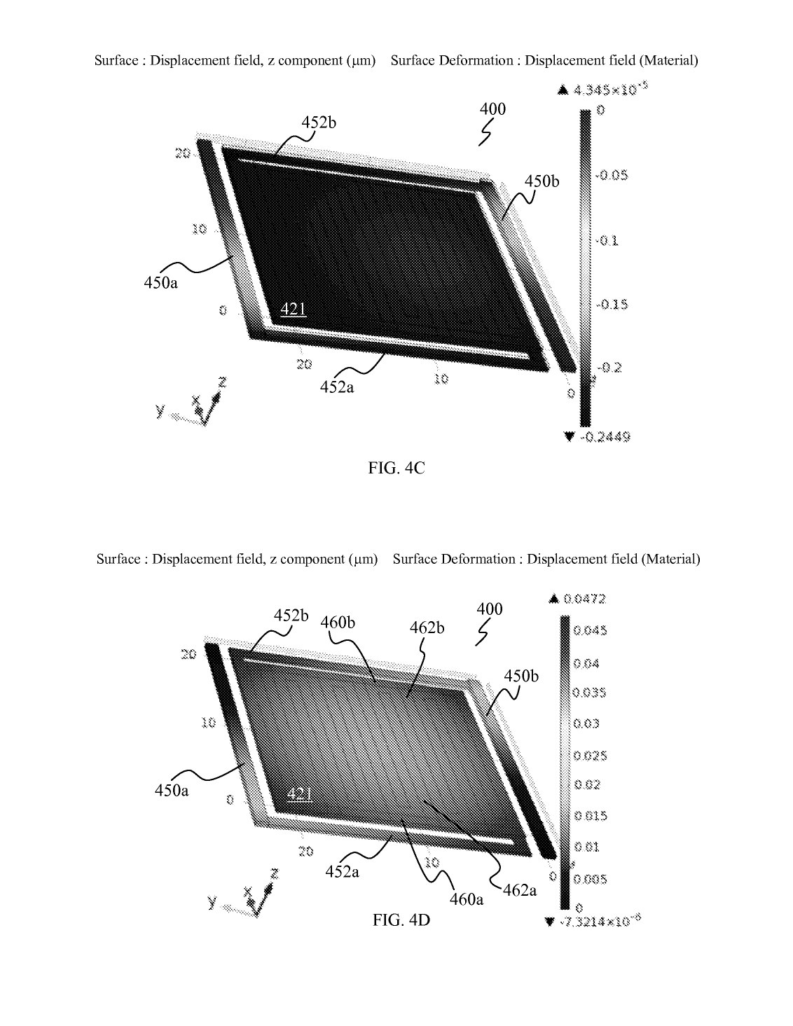

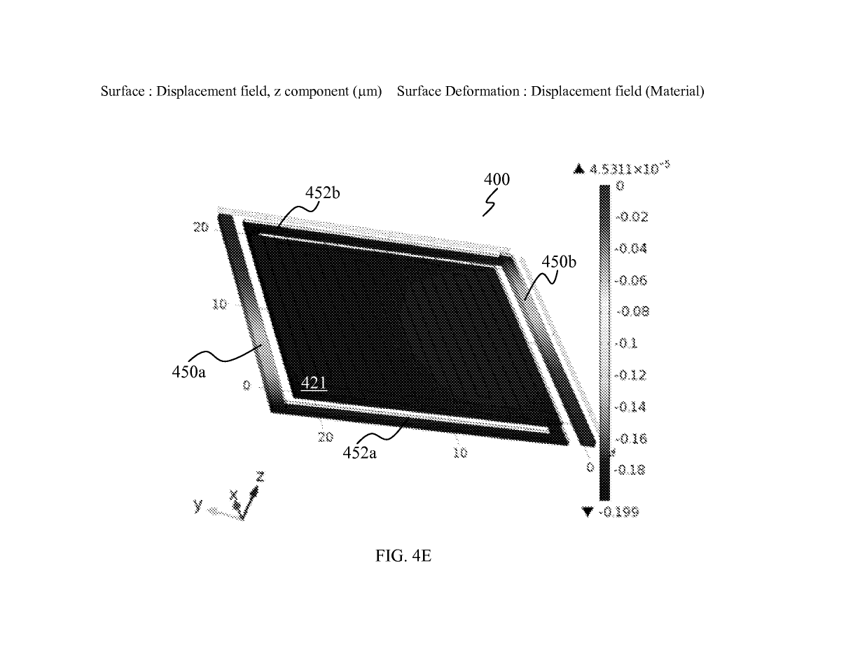

FIGS. 4A and 4B show perspective views of a microbolometer 400 having unimorph bolometer leg structures 450a, 450b, with an applied potential and at ground respectively. The microbolometer 400 includes an absorber 421 including a pair of electrodes arranged in an interdigitated (IDT) pattern on a piezoelectric structure 422. The pair of electrodes may include a first electrode 460a and a second electrode 460b. The microbolometer structure 400 further includes a first bolometer leg 450a coupled to a first thermal isolation leg 452a, which in turn is coupled to the absorber 421, and a second bolometer leg 450b coupled to a second thermal isolation leg 452b, which in turn is coupled to the absorber 421.

Each of the first bolometer leg 450a and the second bolometer leg 450b may include a unimorph structure. Using the first bolometer leg 450a as an example, the first bolometer leg 450a may include a unimorph structure 401 (shown as a cross sectional view) having a single piezoelectric material 456 of a single AN layer arranged over a dielectric layer 458 of SiO₂. The piezoelectric material 456 may be sandwiched between a first electrode 457a and a second electrode 457b.

In various embodiments, the first electrode 457a may be electrically coupled to the second electrode 460b, or the first electrode 457a and the second electrode 460b may be a continuous electrode. In various embodiments, the second electrode 457b may be electrically coupled to the first electrode 460a, or the second electrode 457b and the first electrode 460a may be a continuous electrode.

Using the first bolometer leg 450a as an example, an electrical potential (e.g. about 5 V) may be applied between the first electrode 457a and the second electrode 457b, for example via a voltage source 403, to deform the piezoelectric material 456 to actuate a movement of the absorber 421, bi-directionally along the z-axis. For example, this may mean that a voltage (e.g. about 5 V) may be applied to the second electrode 457b, while the first electrode 457a may be at ground, such that there is a voltage drop between the top and bottom of the first bolometer leg 450a. It should be appreciated that a similar potential or a different potential may be applied to the unimorph structure of the second bolometer leg 450b. In addition, a voltage drop (e.g. about 5 V) may be applied between the first electrode 460a and the second electrode 460b such that there is a voltage drop between the plurality of teeth 462a and the plurality of teeth 462b.

In FIG. 4A, the top or upper side or portion of the first bolometer leg 450a and the second bolometer leg 450b, as well as the first electrode 460a with its associated plurality of teeth 462a, are illustrated in a darker shade to illustrate the applied potential (e.g. 5 V) on these parts. In FIG. 4B, the bottom or lower side or portion of the first bolometer leg 450a and the second bolometer leg 450b, as well as the second electrode 460b with its associated plurality of teeth 462b, are illustrated in a darker shade to show that these parts are at ground.

It should be appreciated that FIGS. 4A and 4B illustrate the same microbolometer 400 when a potential is applied, but respectively and separately showing the portions of the microbolometer 400 at corresponding different potentials (e.g. 5 V or ground).

FIG. 4C shows a simulated displacement of a microbolometer 400 based on the embodiments of FIGS. 4A and 4B at an applied potential of about 20 V between the first electrode 457a and the second electrode 457b, according to various embodiments. The result shows that the respective displacements experienced by the absorber 421, the first thermal isolation leg 452a and the second thermal isolation leg 452b may be highest (in terms of magnitude). The result further shows that the displacement may then decrease moving in the direction towards the respective end portions of the first bolometer leg 450a and the second bolometer leg 450b, away from the first thermal isolation leg 452a and the second thermal isolation leg 452b respectively.

FIG. 4D shows a simulated displacement of a microbolometer 400 based on the embodiments of FIGS. 4A and 4B due to thermal stress, according to various embodiments, illustrating bending or deformation of the membrane and the absorber 421 due to temperature stress for an ambient temperature of about 100° C. The result shows that the respective displacements experienced by the absorber 421, the first thermal isolation leg 452a and the second thermal isolation leg 452b may be highest (in terms of magnitude). The result further shows that the displacement may then decrease moving in the direction towards the respective end portions of the first bolometer leg 450a and the second bolometer leg 450b, away from the first thermal isolation leg 452a and the second thermal isolation leg 452b respectively.

FIG. 4E shows a simulated displacement of a microbolometer 400 based on the embodiments of FIGS. 4A and 4B due to thermal stress for an ambient temperature of about 100° C. and with an applied potential of about 20 V, according to various embodiments. The result shows that the respective displacements experienced by the absorber 421, the first thermal isolation leg 452a and the second thermal isolation leg 452b may be highest (in terms of magnitude). The result further shows that the displacement may then decrease moving in the direction towards the respective end portions of the first bolometer leg 450a and the second bolometer leg 450b, away from the first thermal isolation leg 452a and the second thermal isolation leg 452b respectively. The temperature of about 100° C. may affect the structure behavior by about 20% of the overall piezoelectric movement.

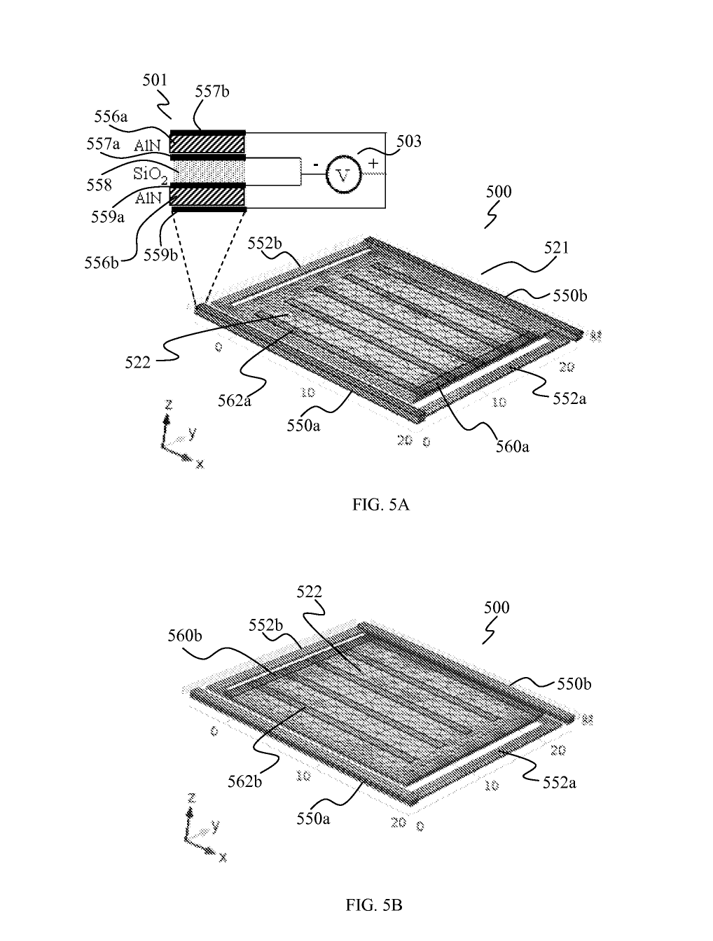

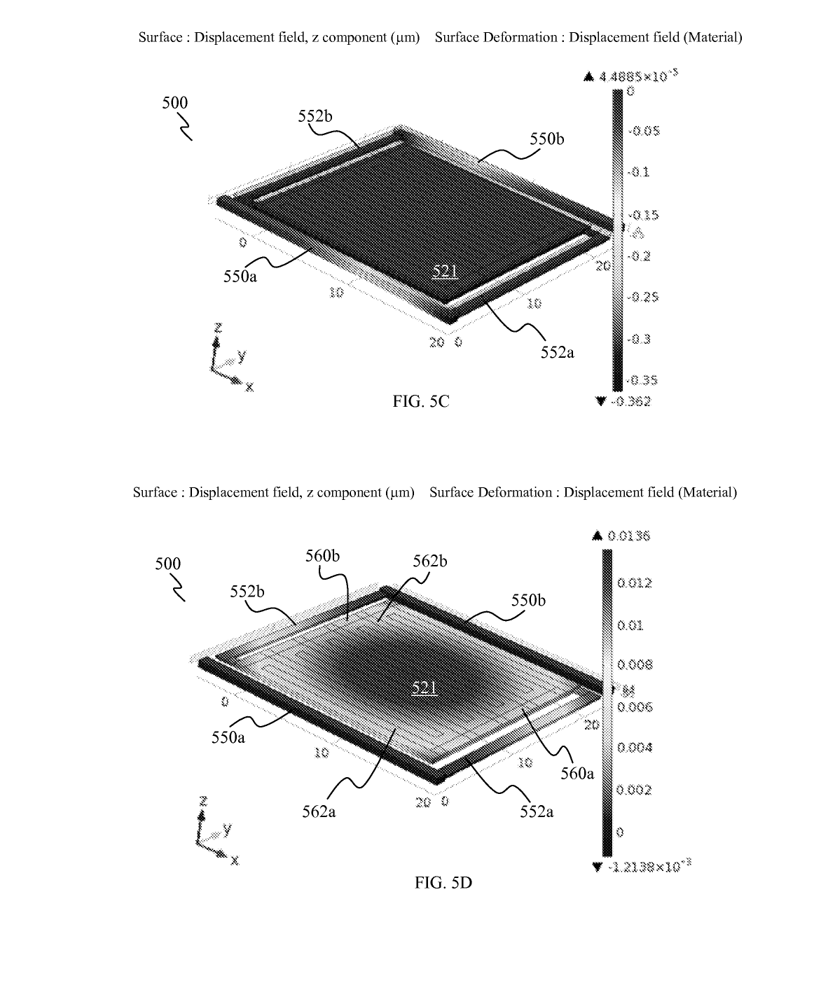

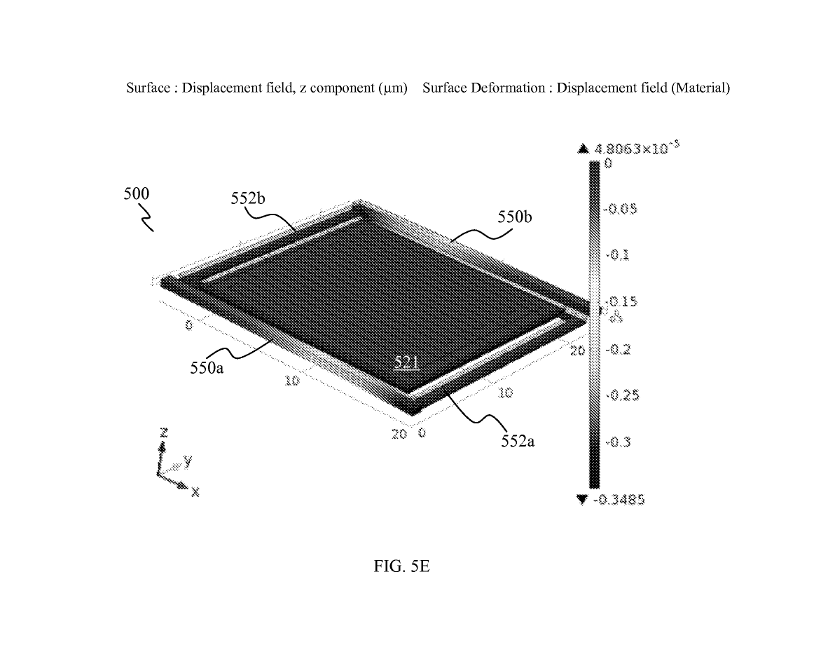

FIGS. 5A and 5B show perspective views of a microbolometer 500 having bimorph bolometer leg structures 550a, 550b, with an applied potential and at ground respectively. The microbolometer 500 includes an absorber 521 including a pair of electrodes arranged in an interdigitated (IDT) pattern on a piezoelectric structure 522. The pair of electrodes may include a first electrode 560a and a second electrode 560b. The microbolometer structure 500 further includes a first bolometer leg 550a coupled to a first thermal isolation leg 552a, which in turn is coupled to the absorber 521, and a second bolometer leg 550b coupled to a second thermal isolation leg 552b, which in turn is coupled to the absorber 521.

Each of the first bolometer leg 550a and the second bolometer leg 550b may include a bimorph structure. Using the first bolometer leg 550a as an example, the first bolometer leg 550a may include a bimorph structure 501 (shown as a cross sectional view) having a first piezoelectric material 556a of a AN layer arranged over a second piezoelectric material 556b of a Al N layer, with a buffer layer 558 of SiO₂ sandwiched therebetween to act as a compensation layer for thermal stress. Therefore, the bimorph structure 501 may have double AlN layers. However, it should be that the bimorph cantilever structure 501 may not be restricted to a two piezoelectric layer system, as it may be possible to use a multiple layer design.

The first piezoelectric material 556a may be sandwiched between a first pair of electrodes, e.g. between a first electrode 557a and a second electrode 557b, while the second piezoelectric material 556b may be sandwiched between a second pair of electrodes, e.g. between a first electrode 559a and a second electrode 559b. The respective first electrodes 557a, 559a may be electrically coupled together, while the respective second electrodes 557b, 559b may be electrically coupled together.

In various embodiments, the respective first electrodes 557a, 559a may be electrically coupled to the second electrode 560b, or the respective first electrodes 557a, 559a and the second electrode 560b may be a continuous electrode. In various embodiments, the respective second electrodes 557b, 559b may be electrically coupled to the first electrode 560a, or the respective second electrodes 557b, 559b and the first electrode 560a may be a continuous electrode.

Using the first bolometer leg 550a as an example, an electrical potential (e.g. about 5 V) may be applied between the respective first electrodes 557a, 559a and the respective second electrodes 557b, 559b, for example via a voltage source 503, to deform the piezoelectric material 556a and the second piezoelectric material 556b to actuate a movement of the absorber 521, bi-directionally along the z-axis. For example, this may mean that a voltage (e.g. about 5 V) may be applied to the respective second electrodes 557b, 559b, while the respective first electrodes 557a, 559a may be at ground, such that there is a voltage drop between the outer (e.g. top and bottom) and the inner parts of the first bolometer leg 550a. It should be appreciated that a similar potential or a different potential may be applied to the bimorph structure of the second bolometer leg 550b. In addition, a voltage drop (e.g. about 5 V) may be applied between the first electrode 560a and the second electrode 560b such that there is a voltage drop between the plurality of teeth 562a and the plurality of teeth 562b.

In FIG. 5A, the top side or portion, and the bottom side or portion of the first bolometer leg 550a and the second bolometer leg 550b, as well as the first electrode 560a with its associated plurality of teeth 562a, are illustrated in a darker shade to illustrate the applied potential (e.g. 5 V) on these parts. In FIG. 5B, the inner central portions (corresponding to the respective first electrodes 557a, 559a) of the first bolometer leg 550a and the second bolometer leg 550b, as well as the second electrode 560b with its associated plurality of teeth 562b, are illustrated in a darker shade to show that these parts are at ground.

It should be appreciated that FIGS. 5A and 5B illustrate the same microbolometer 500 when a potential is applied, but respectively and separately showing the portions of the microbolometer 500 at corresponding different potentials (e.g. 5 V or ground).

FIG. 5C shows a simulated displacement of a microbolometer 500 based on the embodiments of FIGS. 5A and 5B at an applied potential of about 20 V between the respective first electrodes 557a, 559a and the respective second electrodes 557b, 559b, according to various embodiments. The result shows that the respective displacements experienced by the absorber 521, the first thermal isolation leg 552a and the second thermal isolation leg 552b may be highest (in terms of magnitude). The result further shows that the displacement may then decrease moving in the direction towards the respective end portions of the first bolometer leg 550a and the second bolometer leg 550b, away from the first thermal isolation leg 552a and the second thermal isolation leg 552b respectively.

FIG. 5D shows a simulated displacement of a microbolometer 500 based on the embodiments of FIGS. 5A and 5B due to thermal stress, according to various embodiments, illustrating bending or deformation of the membrane and the absorber 521 due to temperature stress for an ambient temperature of about 100° C. The result shows that the displacement experienced at the central region of the absorber 521 may be lowest (in terms of magnitude), where the displacement gradually increases away from the central region towards the edge regions of the absorber 521. The result further shows that the displacement experienced in the vicinity of the respective coupling points between the absorber 521 and the respective first thermal isolation leg 552a and second thermal isolation leg 552b may be highest, which may then decrease moving in the direction towards the respective end portions of the first bolometer leg 550a and the second bolometer leg 550b, away from the first thermal isolation leg 552a and the second thermal isolation leg 552b respectively.

FIG. 5E shows a simulated displacement of a microbolometer 500 based on the embodiments of FIGS. 5A and 5B due to thermal stress for an ambient temperature of about 100° C. and with an applied potential of about 20 V, according to various embodiments. The result shows that the respective displacements experienced by the absorber 521, the first thermal isolation leg 552a and the second thermal isolation leg 552b may be highest (in terms of magnitude). The result further shows that the displacement may then decrease moving in the direction towards the respective end portions of the first bolometer leg 550a and the second bolometer leg 550b, away from the first thermal isolation leg 552a and the second thermal isolation leg 552b respectively. The temperature of about 100° C. may affect the structure behavior by about 2.8% of the overall piezoelectric movement, where the stress and temperature compensation offered by the buffer material 558 of the bimorph structure 501 may reduce the effect of temperature by about 10 times as compared to the unimorph structure 401.

Comparing FIGS. 4C and 5C, a much higher displacement may be observed for the microbolometer 500 having the bimorph structure 501, compared to the microbolometer 400 having the unimorph structure 401. It should be appreciated that the overall displacement may also be dependent on the applied potential and/or the length of the cantilever bolometer legs and/or the thickness of the piezoelectric material(s) in the bolometer legs.

Further, as compared to the unimorph structure 401, by using a bimorph structure 501, the temperature dependent movement of the membrane or the absorber may be reduced by a factor of approximately 10, from about 20% to about 2.8%, regarding the overall piezoelectric movement.

As shown in FIGS. 4C and 5C, the membrane movement of the detector of various embodiments may be controlled in the z-axis for the unimorph structure and the bimorph structure respectively.

Various embodiments may provide an uncooled high temperature stable detector or system for multi- and hyperspectral infrared (IR) imaging. The microbolometer membrane including an absorber layer may be movable in the +/−z-axis or z-direction by using a piezoelectric cantilever and actuator on the bolometer legs. In various embodiments, with a movable absorber and a static reflector forming a Fabry-Perot structure or optical cavity, it may be possible to align the absorption wavelength to the tunable filter adjusted IR wavelength which may be arranged prior to the microbolometer membrane, which may result in an absolute value detection of the IR light. Due to the high freedom of movement of the detector of various embodiments, it may be possible to scan the whole infrared light spectrum reaching from about 2 μm to about 20 μm. Combining both Mid- and Far infrared light information may provide a complete further dimension of analyzing our environment, with possible application areas such as remote imaging, detection of explosives, food inspection and waste management, among others.

It should be appreciated that various embodiments may provide one or more of the following : (1) piezoelectric actuated infrared (IR)-absorption structure for multi- and hyperspectral IR detection; (2) enhanced bidirectional, tunable z-axis movement, with any piezoelectric actuation approach; (3) highly accurate linear movement behavior of the bolometer membrane and therefore good wavelength absorption selectivity; (4) bimorph, buffered ambient temperature stable cantilever for Fabry-Perot (FP) IR absorber (or membrane); (5) large temperature operation range due to the bimorph buffered structure; (6) stable absorber movement behavior for high temperature application(s); (7) active temperature compensation for unimorph cantilever FP IR absorber; (8) high precision, full Mid-IR and Far-IR spectrum absorption; (9) full scale of mid and far infrared light may be absorbed using the structure of various embodiments, dependent on the desired application(s).

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A detector comprising:
an electromagnetic absorber;
an electromagnetic reflector arranged spaced apart from the electromagnetic absorber, wherein the electromagnetic absorber is configured to absorb an electromagnetic radiation, the electromagnetic radiation having a wavelength defined based on a distance between the electromagnetic absorber and the electromagnetic reflector; and
an actuating element configured to move the electromagnetic absorber from an equilibrium position bi-directionally relative to the electromagnetic reflector to change the distance, and
wherein the detector is configured to determine a change in a property associated with the electromagnetic absorber in response to the electromagnetic radiation.

2. The detector as claimed in claim 1, wherein the actuating element is coupled to the electromagnetic absorber.

3. The detector as claimed in claim 1, wherein the actuating element comprises a piezoelectric material.

4. The detector as claimed in claim 3, further comprising at least one support structure coupled to the electromagnetic absorber, the at least one support structure comprising the piezoelectric material.

5. The detector as claimed in claim 4, wherein the at least one support structure comprises:
a first support structure coupled to a first side of the electromagnetic absorber; and
a second support structure arranged coupled to a second side of the electromagnetic absorber opposite to the first side.

6. The detector as claimed in claim 4, wherein the at least one support structure comprises a dielectric material, wherein the piezoelectric material and the dielectric material are arranged one over the other.

7. The detector as claimed in claim 4, wherein the at least one support structure further comprises another piezoelectric material, wherein the piezoelectric material and the other piezoelectric material are arranged one over the other.

8. The detector as claimed in claim 7, wherein the at least one support structure further comprises a buffer material between the piezoelectric material and the other piezoelectric material, the buffer material configured to provide compensation against thermal stress.

9. The detector as claimed in claim 1, further comprising a thermally insulating material between the actuating element and the electromagnetic absorber to provide thermal isolation between the actuating element and the electromagnetic absorber.

10. The detector as claimed in claim 1, wherein the electromagnetic absorber comprises:
an acoustic wave resonator comprising
a pair of electrodes; and
a piezoelectric structure,
wherein the piezoelectric structure is electrically coupled to the pair of electrodes,
wherein the acoustic wave resonator is configured to generate an acoustic wave, and
wherein the detector is configured to determine a change in a frequency of the acoustic wave in response to the electromagnetic radiation.

11. The detector as claimed in claim 10, wherein the pair of electrodes is arranged in a first layer and the piezoelectric structure is arranged in a second layer adjacent to the first layer.

12. The detector as claimed in claim 10, wherein each of the pair of electrodes comprises a plurality of teeth.

13. The detector as claimed in claim 13, wherein the pair of electrodes is arranged in an interdigitated pattern.

14. The detector as claimed in claim 1, further comprising a filter for filtering an initial electromagnetic radiation incident on the detector prior to reaching the electromagnetic absorber.

15. The detector as claimed in claim 1, wherein the detector comprises an infrared detector.

16. The detector as claimed in claim 15, wherein the infrared detector is configured to detect infrared radiation of a wavelength up to about 20 μm.

17. The detector as claimed in claim 1, wherein the electromagnetic absorber comprises a microbolometer.

18. A method of controlling a detector, the method comprising:
operating an actuating element of the detector to move an electromagnetic absorber of the detector from an equilibrium position in a direction selected from two opposite directions the electromagnetic absorber is movable, relative to an electromagnetic reflector of the detector arranged spaced apart from the electromagnetic absorber to change a distance between the electromagnetic absorber and the electromagnetic reflector, wherein the electromagnetic absorber is configured to absorb an electromagnetic radiation, the electromagnetic radiation having a wavelength defined based on the distance; and
determining a change in a property associated with the electromagnetic absorber in response to the electromagnetic radiation.

19. The method as claimed in claim 18, wherein operating an actuating element of the detector comprises operating the actuating element to move the electromagnetic absorber of the detector from the equilibrium position bi-directionally in the two opposite directions relative to the electromagnetic reflector.

20. The method as claimed in claim 18, wherein the actuating element comprises a piezoelectric material.
